(19) United States
(12) Patent Application Publication
(10) Pub. No.: US 2002/0188501 A1
(43) Pub. Date: Dec. 12, 2002

(54) Method and system for providing rebates to automobile owners based on purchases made at participating retailer locations

(76) Inventor: David Lefkowith, Los Angeles, CA (US)

Correspondence Address: BROOKS & KUSHMAN P.C./FGTI, 1000 TOWN CENTER, 22ND FLOOR, SOUTHFIELD, MI, 48075, US

(21) Appl. No.: 09/681,815

(22) Filed: Jun. 11, 2001

(51) Int. Cl. G06F 17/60

(52) U.S. Cl. 705/14

(57) ABSTRACT

A method and system for providing rebates to automobile owners, lessees and renters based on purchases made at participating retailer locations include providing a customer with an identification badge containing customer information upon selling, leasing or renting an automobile to a customer. At participating retailer locations, the customer presents the badge at the point of sale. The customer information is electronically retrieved from the badge and electronically transmitted together with the point of sale purchase information to a central rebate processing center. Quarterly or otherwise, a rebate is provided to the customer based on the amount of purchases made by the customer at the participating retailer locations.

### BACKGROUND OF INVENTION

The present invention relates generally to the field of marketing and, more particularly, to a method and system for providing rebates to automobile owners based on purchases made at participating retailer locations.

Automobile buyers today are inundated with brand options, incentives and product information placing them at a tremendous bargaining advantage over automobile dealers. As a result, profit margins in the automotive industry at both the manufacturer and dealer level are at a bare minimum. Automobile manufacturers and dealers are currently unable to reduce vehicle pricing or otherwise increase industry-funded incentives. To remain competitive, the manufacturers and dealers must turn to innovative and non-traditional methods of wooing new car buyers.

One manner in which the automobile industry can increase volume and overall profits is by offering buyer incentives funded by non-industry merchants in exchange for an increased merchant customer base. Doing so benefits all parties involved: the manufacturer, the dealer, the non-industry merchant and ultimately the customer. The manufacturers and dealers benefit, at no additional cost to them, through increased sales volume as a result of their ability to offer additional purchase incentives to automobile buyers. The participating merchants benefit as a result of an increased customer base borrowed from their participating automotive partners. In the end, the customers enjoy the incentives offered by the non-industry merchants.

What is needed is a solution which enables the automobile industry and participating non-industry merchants to effectively and profitably offer buyers a non-industry funded incentive to purchase automobiles.

What is needed is a method and system for providing rebates to automobile owners based on purchases made at participating retailer locations.

### SUMMARY OF INVENTION

One embodiment of the present invention comprises a method for providing rebates to automobile owners based on purchases made at participating retailer locations. At an automobile dealership, an automobile dealer sells an automobile to a customer and provides the customer with a customer identification badge containing a plurality of customer information. At a point of sale at a participating retailer location, the customer information stored within the customer identification badge is retrieved and transmitted together with the point of sale purchase information to a rebate processing center. At the rebate processing center, a rebate is generated based on the point of sale purchase information and the rebate is provided to the customer.

Another embodiment of the present invention comprises a system for providing rebates to automobile owners based on purchases made at participating retailer locations. One element of the system includes a first computer at an automobile dealership. The first computer is configured to encode a customer identification badge with customer information pertaining to a customer who has purchased an automobile from the automobile dealership. Another element of the system includes a second computer at a participating retailer location. The second computer is configured to retrieve the customer information from the customer identification badge at a point of sale and transmit the customer information and point of sale purchase information to a third computer at a rebate processing center. Yet another element of the system includes a third computer at a rebate processing center. The third computer is configured to receive the point of sale purchase information and the customer information from the second computer and generate a rebate for the customer wherein the rebate is based on the purchase information.

### BRIEF DESCRIPTION OF DRAWINGS

FIG. 1 is a block flow diagram illustrating a preferred method 100 for implementing the present invention;

FIG. 2 illustrates a preferred environment in which a system 200 for implementing the present invention operates;

FIG. 3 illustrates a graphical user interface (GUI) 300 for use by automobile dealers 202 in generating a customer identification badge 210;

FIG. 4 illustrates a GUI 400 for generating quarterly rebate checks 232 at the rebate processing center 222; and

FIG. 5 illustrates a GUI 500 for browsing and managing data contained within the at least one database 228 at the rebate processing center 222.

### DETAILED DESCRIPTION

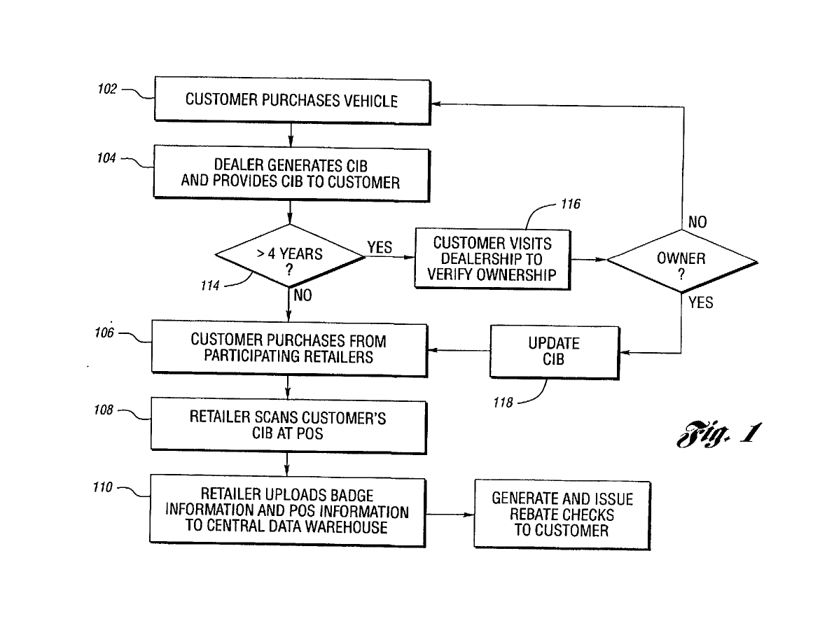

FIG. 1 is a block flow diagram illustrating a preferred method 100 for implementing the present invention.

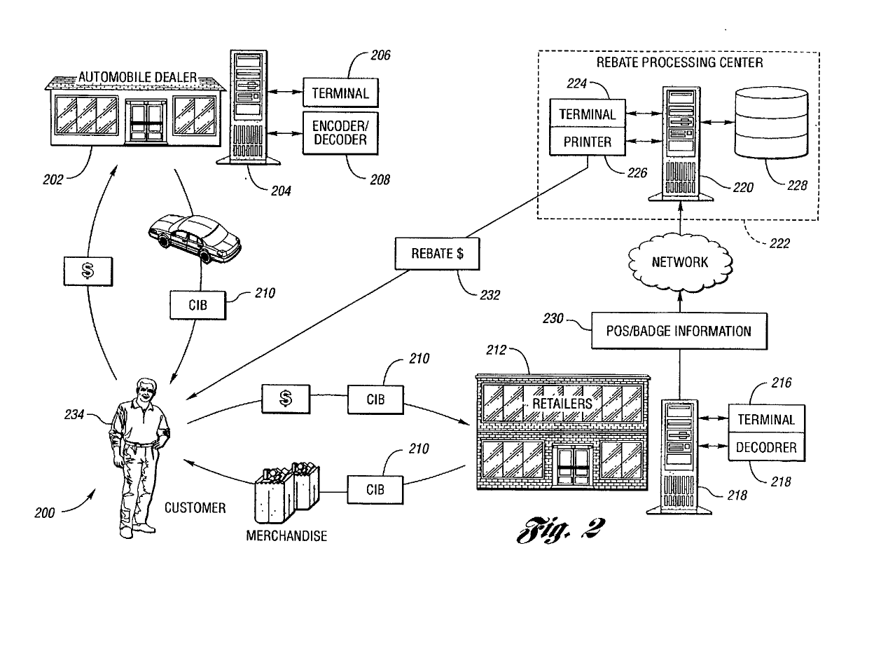

FIG. 2 illustrates a preferred environment in which a system 200 for implementing the present invention operates. Those familiar in the art to which the present invention pertains, however, will recognize various alternative methods and systems may be implemented within the scope of the claimed invention.

Referring now to FIG. 1, the preferred method 100 begins as represented in block 102 with a customer purchasing an automobile from an automobile dealer. In addition to the traditional automobile purchase transaction, the automobile dealer generates a customer identification badge (“CIB”) 210 upon completion of the automobile purchase and provides the CIB 210 to the customer, as represented in block 104.

Generally, the CIB 210 is a physical device for retaining certain information (“badge information”). Badge information includes but is not limited to: a customer identification code, the name of the customer, the customer's contact information, the make and model of vehicle the customer purchased, the vehicle identification number (VIN) corresponding to the vehicle the customer owns, and an identification code corresponding to the dealer that generated or last updated the CIB.

Notably, the CIB may take several physical forms well known in the general field of customer identification and portable data storage devices. For example, the customer identification badge may comprise a magnetically encoded “credit card” type device. As is well known in the art of encoding/decoding magnetic tapes and the like, the automobile dealer 202 (FIG. 2) may employ an encoding device 208 to magnetically encode the badge information onto the CIB 210.

Another embodiment of the customer identification badge 210 comprises an object containing a bar code (wallet card, key chain item, etc. ). As is well known in the art of encoding/decoding bar codes and the like, the automobile dealer 202 may employ an encoding device (i.e., bar code printer) 208 to encode the badge information via bar code onto the CIB 210. Alternately, a sticker or the like bearing the bar code is generated and applied to the customer's vehicle or another object.

A third embodiment of the CIB 210 comprises a radio frequency transponder inserted into a wallet card, key chain, etc. One example of such a device is the Exxon Corporation's “Mobil SpeedPass” key chain item.

Yet another embodiment of the CIB 210 comprises a computer memory chip module or the like having persistent data storage and input/output capabilities. Preferably, the CIB is physically mounted to the automobile in a permanent or easily detachable manner.

Referring to FIG. 2, the automobile dealer 202 is equipped with a computer 204 operably connected to a terminal 206 for input and output, and an encoder/decoder or other peripheral output unit 208 (where applicable) for generating or otherwise programming and updating the CIB 210.

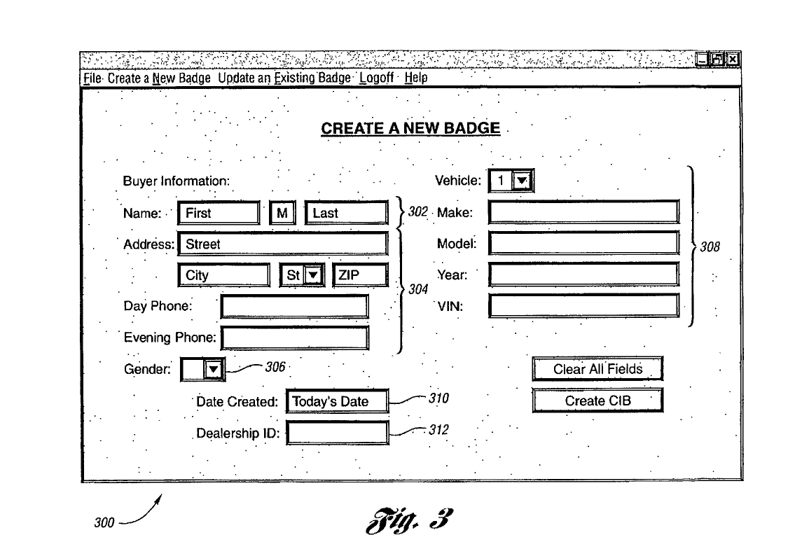

Referring now to FIG. 3, a graphical user interface (GUI) 300 for use by automobile dealers 202 in generating or updating the CIB 210 is illustrated. In accord with a preferred embodiment, the GUI 300 is configured to receive input including but not limited to the buyer's name 302, contact information 304, gender 306, vehicle information 308, the date the badge was created 310 and a dealership identification code 312.

Referring again to the preferred method for implementing the present invention illustrated in FIG. 1, the customer completes a purchase at a participating retailer as represented in block 106. Notably, participating retailers are not limited to those participating in or associated with the automotive industry. Participating retailers may range from grocery stores to clothing stores to hardware and home improvement stores. It is envisioned that nearly any retail (as well as several non-retail) merchants can participate in and benefit from the present invention.

Referring again to FIG. 2, participating retailers 212 are equipped with a computer 214 operably connected to a terminal 216 for input and output, a decoder 218 or other peripheral device for decoding or otherwise retrieving information stored within the customer's customer identification badge 210.

Referring also to FIG. 1, the retailer 212 scans or otherwise retrieves the badge information from the CIB 210 at the point of sale (POS), as represented in block 108.

After the sale is complete and the badge information has been retrieved, the participating retailer 212 (FIG. 2) uploads or otherwise transmits the badge information and POS information 230 to the rebate processing center 222 as represented in block 110. Preferably, the information is uploaded from the computer 214 at the participating retailer location 212 to a computer 220 at the rebate processing center 222 and stored within at least one database (“database”) 228 operably connected to the computer 220.

Operable connections between computers 214 and 220 include but are not limited to a wide area network (WAN), a local area network (LAN), telnet, dial-up, intranet, ethernet, or the Internet including the World Wide Web.

Point of sale information (POS) 230 uploaded to the rebate processing center 222 and stored within the database 228 includes but is not limited to a retailer identification code, the date of purchase, items purchased, amount of purchase, payment method, rebate amount, and rebate payment information (i.e., arrangements concerning the amount of the rebate that the retailer will pay and how that payment will be executed).

Preferably, the POS information and corresponding badge information is uploaded to the rebate processing center 222 daily. The present invention may be configured, however, such that the information 230 is uploaded in real time during the sale transaction or shortly thereafter.

Referring again to the preferred method illustrated in FIG. 1, a rebate 232 is generated at the central data warehouse 222 and issued to the customer 234, as represented in block 112.

The customer rebate 232 may take on several forms. In one embodiment, the rebate comprises a check printed by a printer 226 operably connected to the computer 220 at the rebate processing center 222. After the rebate check 232 is generated, it is mailed to the customer 234. In another embodiment, the rebate is directly deposited into a bank account specified by the customer upon generating the CIB 210 at the dealer 202 or otherwise. In yet another embodiment, the rebate comprises customer-specific credit at one or more of the participating (or non-participating) retail locations 212.

Preferably, rebates 232 are issued to customers 234 quarterly. Alternatively, the rebates may be processed and issued in real time during the purchase transaction at the retailer 212, or shortly thereafter (following upload to the rebate processing center 222).

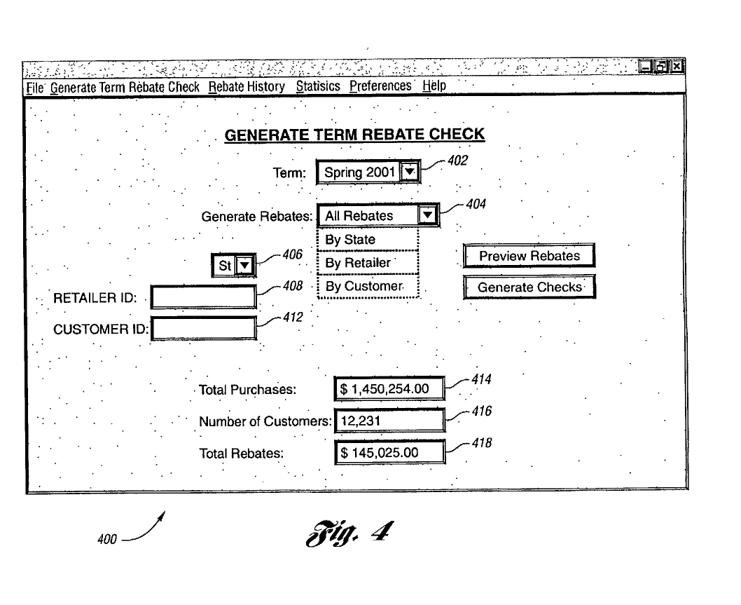

FIG. 4 illustrates a preferred GUI 400 for processing and generating quarterly rebate checks at the rebate processing center 222 (illustrated in FIG. 2). GUI 400 comprises a plurality of data fields for input and output.

A term field 402 allows a user to specify the term (e.g., fiscal quarter) for which rebate checks are to be generated. A rebate format drop-down menu 404 allows a user to specify the overall manner in which the rebates are generated (i.e., by state, retailer, customer, all rebates, etc. ). In the event that a user selects a “By State” rebate format 404, the user additionally selects a state from a drop-down menu 406. In the event a user selects a “By Retailer” rebate format 404, the user additionally inputs a retailer identification code into a “Retailer ID” form data field 408. To browse a listing of retailer identification codes, the user selects a “Retailer ID” hyperlink 410 and is presented with a searchable listing of all retailers (not shown) contained within the database 228 (illustrated in FIG. 2). In the event a user selects a “By Customer” rebate format 404, the user inputs a customer identification code into a “Customer ID” form data field 412. To browse a listing of customer identification codes, the user selects a “Customer ID” hyperlink 414 and is presented with a searchable listing of all customers (not shown) contained within the database 228 (illustrated in FIG. 2).

Based on the selected rebate format, a variety of corresponding information is provided. Corresponding rebate information includes but is not limited to the total amount of purchases 414 at the participating retailer locations, the total number of customers 416 receiving a rebate this term, and a total rebate amount 418 for the current rebate term 402.

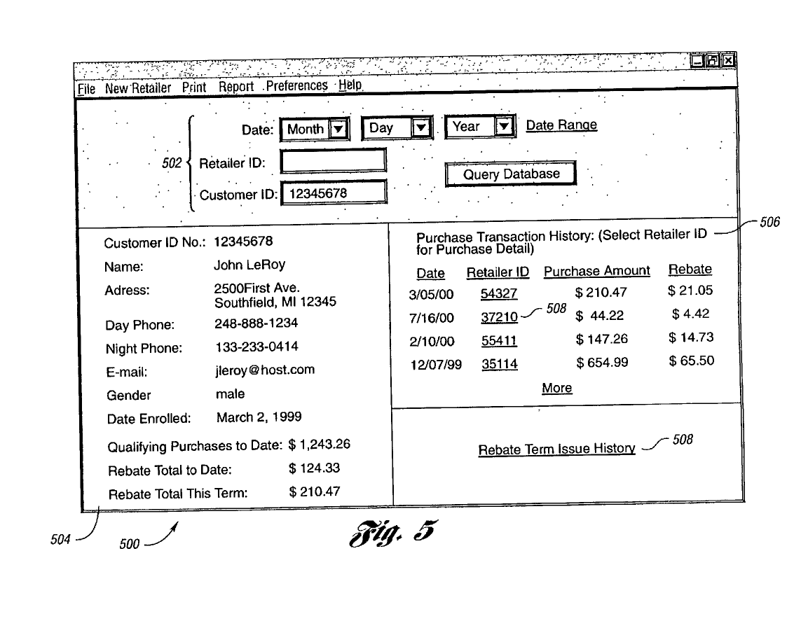

FIG. 5 illustrates a GUI 500 for browsing and managing data contained within the database 228 (illustrated in FIG. 2) at the rebate processing center 222.

A user is presented with a variety of search criteria 502 with which to define a query of the database 228. Search criteria include but are not limited to rebates reported or issued on a particular date, rebates reported or issued over a particular date range, rebates reported from a particular retailer and rebates issued to a particular customer.

Query report/results frames 504 and 506 present the results of a query defined by search criteria 502. Notably, the content and format of the query report frames depend upon the type of query selected. As shown in FIG. 5, the query report contains a plurality of customer information 504, the customer's purchase transaction history 506 and a hyperlink 508 to a customer's rebate issue history.

More specifically, the purchase transaction history 506 comprises a chronological listing of the date, retailer, purchase amount and rebate associated with each customer purchase transaction at a participating retailer location. By selecting a hyperlink 510 corresponding to a particular retailer within the listing, the user is presented with a plurality of database information pertaining to that retailer (not shown). Retailer information includes but is not limited to the retailer identification code, the name and address of the retailer, the amount of qualifying purchases made at the retailer's location, the amount of rebates issued by the retailer, and information (i.e., terms) pertaining to the retailer's customer identification participation agreement.

By selecting the “Rebate Term Issue History” hyperlink 508, the user is presented with a chronological listing (not shown) of rebates previously issued to the customer as well as the date issued, the address to which the rebates were sent or the bank account into which the rebates were deposited.

Referring again to FIG. 1, block 114, a customer is required to update his or her CIB annually or at some other predefined time interval. In one embodiment, the customer updates his or her customer identification badge by visiting a participating dealership and verifying that he or she (the customer) continues to be the current owner of his or her automobile, as represented in block 116.

Accordingly, the issuance of customer rebates based on customer purchases at participating retail locations is contingent upon the customer's continued ownership of a vehicle purchased at a participating automobile dealer.

If the customer proves he or she continues to be the owner of the vehicle originally purchased from a participating dealer, the customer's CIB is updated as represented in block 118. At this point, the customer is free to continue receiving rebates for purchases made at participating retail locations as represented in blocks 106-112. If the customer is unable to prove that he or she continues to be the owner of the vehicle, the customer either purchases another vehicle from a participating retailer as represented in block 102 or ends participation with the present invention altogether.

In an alternate embodiment of the present invention, customers who lease or rent vehicles from the automobile dealers (as opposed to purchase) participate in the present invention and receive rebates for their purchases at participating retailer locations during the term of the customer's lease or rental term.

According to another alternate embodiment of the present invention, at least a portion of the badge information (e.g., name, contact information, etc.) is uploaded directly from the computer 204 (FIG. 2) at the participating dealer location 202 to the computer 220 at the rebate processing center 222. This feature reduces the amount of information that must be stored on the CIB to only a customer identification code. As the customer's POS information is uploaded from the participating retailer locations 212 to the rebate processing center 222, computer 220 reconciles the purchase transaction information with the customer based on his or her customer identification code.

In yet another alternate embodiment, participating retailers 212 are billed at regular intervals (i.e., monthly) by the rebate processing center 222 for rebates issued. An automatic electronic payment/debit system well known in the field of commercial payment transactions is also envisioned.

While the best mode for carrying out the invention has been described in detail, those familiar with the art to which this invention relates will recognize various alternative designs and embodiments for practicing the invention as defined by the following claims.

1. A method for providing rebates to automobile owners based on purchases made at participating retailer locations, the method comprising:
selling an automobile to a customer wherein the customer is provided with a customer identification badge containing a plurality of customer information;
retrieving the customer information stored within the customer identification badge at a point of sale;
transmitting point of sale purchase information and the customer information to a rebate processing center remote from the point of sale; and
providing a rebate to the customer wherein the rebate is calculated based on the purchase information.

2. The method of claim 1, wherein the customer identification badge expires after a predefined time interval.

3. The method of claim 1 wherein the customer identification badge comprises a magnetically encoded wallet card.

4. The method of claim 1 wherein the customer identification badge comprises a bar code.

5. The method of claim 1 wherein the customer identification badge comprises a persistent memory module having input and output capabilities wherein the module is attached to the automobile.

6. The method of claim 1 wherein the rebate comprises a check mailed to the customer at quarterly annual time intervals.

7. The method of claim 1 wherein the rebate is electronically deposited into a bank account specified by the customer.

8. The method of claim 1 wherein the purchase information comprises a rebate amount that a participating retailer is willing to pay.

9. The method of claim 1 wherein the retailer provides payment to the rebate processing center to pay for the rebate.

10. The method of claim 1 additionally comprising transmitting the customer information from the automobile dealership to the rebate processing center.

11. The method of claim 1 wherein the automobile is leased to the customer.

12. The method of claim 1 wherein the automobile is rented to the customer.

13. A system for providing rebates to automobile owners based on purchases made at participating retailer locations, the system comprising:
a first computer configured to encode a customer identification badge with customer information pertaining to a customer who has purchased an automobile;
a second computer at a participating retailer location, the second computer configured to:
(i)retrieve the customer information from the customer identification badge at a point of sale; and
(ii)transmit the customer information and point of sale purchase information to a third computer at a rebate processing center; and a third computer at a rebate processing center, the third computer configured to:
(i)receive the point of sale purchase information and the customer information from the second computer; and
(ii)generate a rebate for the customer wherein the rebate is based on the purchase information.

14. The system of claim 13 wherein the customer identification badge is configured to expire at a predefined time period after it is encoded.

15. The system of claim 13 wherein the customer identification badge comprises a magnetically encoded wallet card.

16. The system of claim 13 wherein the customer identification badge comprises a bar code.

17. The system of claim 13 wherein the customer identification badge comprises a persistent memory module having input and output capabilities wherein the module is attached to the automobile.

18. The system of claim 13 wherein the third computer is additionally configured to facilitate electronic direct deposit of the rebate into a bank account specified by the customer.

19. The system of claim 13 wherein the purchase information comprises a rebate amount that the participating retailer is willing to pay.

20. The system of claim 13 wherein the second computer at the retailer location is additionally configured to facilitate the retailer's electronic payment to the rebate processing center for the rebate.

21. The system of claim 13 wherein the first computer is additionally configured to transmit the customer information to the third computer at the rebate processing center.

22. The system of claim 13 wherein the first computer is configured to encode a customer identification badge with customer information pertaining to a customer who has leased an automobile from the dealer.

23. The method of claim 13 wherein the first computer is configured to encode a customer identification badge with customer information pertaining to a customer who has rented an automobile from the dealer.
